(19) United States
(12) Patent Application Publication
(10) Pub. No.: US 2025/0075282 A1
(43) Pub. Date: Mar. 6, 2025

(54) PRESS HARDENING STEEL (PHS) WELDED BLANKS WITH ENHANCED TOUGHNESS

(71) Applicant: GM GLOBAL TECHNOLOGY OPERATIONS LLC, Detroit, MI (US)

(72) Inventors: Zhou WANG, Shanghai (CN); Zhao Li, Shanghai (CN); Wei Xu, Shenyang (CN); Jianfeng Wang, Nanjing (CN)

(21) Appl. No.: 18/789,217

(22) Filed: Jul. 30, 2024

(30) Foreign Application Priority Data
Aug. 28, 2023 (CN) 2023110936267

(51) Int. Cl. C21D 9/00; B23K 26/24; B32B 15/04; B32B 15/18; C21D 1/18; C21D 6/00; C21D 8/00; C22C 38/02; C22C 38/04; C22C 38/34; C22C 38/46; C22C 38/48; C22C 38/50; C22C 38/58

(52) U.S. Cl. CPC C21D 9/0068; B23K 26/24; B32B 15/043; B32B 15/18; C21D 1/18; C21D 6/004; C21D 6/005; C21D 6/008; C21D 8/005; C22C 38/02; C22C 38/04; C22C 38/34; C22C 38/46; C22C 38/48; C22C 38/50; C22C 38/58; B32B 2255/06; B32B 2255/20

(57) ABSTRACT

A method for manufacturing a component includes providing a first PHS blank including an aluminum silicon (AlSi) coating; providing a second PHS blank, wherein the second PHS blank includes chromium (Cr) at a higher concentration than the first PHS blank and does not include the aluminum silicon (AlSi) coating; welding the first PHS blank to the second PHS blank to form a welded blank including a weld seam between the first PHS blank and the second PHS blank; transferring the welded blank to a furnace; heat soaking the welded blank in the furnace at a predetermined temperature for a predetermined period; and pressing, forming, and quenching the welded blank in a stamp/press to form a component.

### CROSS-REFERENCE TO RELATED APPLICATIONS

This application claims the benefit of Chinese Patent Application No. 202311093626.7, filed on Aug. 28, 2023. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to manufacturing of components using press hardening steel (PHS), and more particularly to PHS blanks that are welded, austenitized, and formed, pressed, and quenched.

Press hardening steel (PHS) increases the strength of the steel. PHS is often used for load-bearing components of vehicles, construction equipment, and/or other devices. During press-hardening, two or more PHS blanks are welded together and heat soaked for a predetermined period at temperature range for austenitization. After austenitizing, the welded PHS blanks are transferred to a stamp/press, and formed, pressed, and quenched using one or more dies.

When PHS blanks are uncoated, an oxide layer may be formed on a surface of the blank during austenitization and transfer to the stamp/press. As a result, the oxide layer needs to be removed after forming, pressing, and quenching. For example, the oxide layer may be descaled by shot blasting, which increases cost and production cycle time.

To avoid formation of the oxide layer, the PHS blanks may be coated with a coating layer that inhibits the formation of the oxide layer. For example, the PHS blanks may be coated with aluminum silicon alloy (AlSi) to inhibit the oxide coating and to avoid the cost and time required to remove the oxide layer.

### SUMMARY

A method for manufacturing a component includes providing a first PHS blank including an aluminum silicon (AlSi) coating; providing a second PHS blank, wherein the second PHS blank includes chromium (Cr) at a higher concentration than the first PHS blank and does not include the aluminum silicon (AlSi) coating; welding the first PHS blank to the second PHS blank to form a welded blank including a weld seam between the first PHS blank and the second PHS blank; transferring the welded blank to a furnace; heat soaking the welded blank in the furnace at a predetermined temperature for a predetermined period; and pressing, forming, and quenching the welded blank in a stamp/press to form a component.

In other features, the predetermined temperature is in a range from 900° C. to 950° C. The second PHS blank includes iron (Fe); carbon (C) in a range from 0.05 wt % to 0.35 wt %; manganese (Mn) in a range from 0.05 wt % to 3.0 wt %; chromium (Cr) in a range from 1.2 wt % to 12 wt %; and silicon (Si) in a range from 0.3 wt % to 2.0 wt %.

In other features, the second PHS blank includes nickel (Ni) in a range from 0.01 wt % to 1.5 wt %; vanadium (V) in a range from 0.01 wt % to 0.5 wt %; niobium (Nb) in a range from 0.01 wt % to 0.3 wt %; and titanium (Ti) in a range from 0.01 wt % to 0.3 wt %. The second PHS blank includes Ni in a range from 0.01 wt % to 1.5 wt %. The second PHS blank includes vanadium (V) in a range from 0.01 wt % to 0.5 wt %. The second PHS blank includes niobium (Nb) in a range from 0.01 wt % to 0.3 wt %. The second PHS blank includes titanium (Ti) in a range from 0.01 wt % to 0.3 wt %. The chromium (Cr) is in a range from 1.2 wt % to 6 wt % and a ratio of Cr/Si is greater than 0.5 and less than 3.

In other features, after pressing, forming, and quenching, the second PHS blank includes a surface oxidation layer having a thickness less than 1.5 μm. After pressing, forming, and quenching, the second PHS blank includes Cr-enriched carbides in a range from 0.1 vol. % to 10 vol. %. After pressing, forming, and quenching, the weld seam includes Al less than 0.8 wt. % and Cr greater than 0.5 wt. %. After pressing, forming, and quenching, a microstructure of the weld seam includes ferrite less than 5 vol. %, martensite greater than 80 vol. %.

A component including two or more welded PHS blanks includes a first PHS blank including an aluminum silicon (AlSi) coating and a second PHS blank. The second PHS blank includes chromium at a higher concentration than the first PHS blank and does not include the aluminum silicon (AlSi) coating and a weld seam between the first PHS blank and the second PHS blank.

In other features, the second PHS blank includes iron (Fe); carbon (C) in a range from 0.05 wt % to 0.35 wt %; manganese (Mn) in a range from 0.05 wt % to 3.0 wt %; chromium (Cr) in a range from 1.2 wt % to 12 wt %; and silicon (Si) in a range from 0.3 wt % to 2.0 wt %.

In other features, the second PHS blank further includes at least one of nickel (Ni) in a range from 0.01 wt % to 1.5 wt %; vanadium (V) in a range from 0.01 wt % to 0.5 wt %; niobium (Nb) in a range from 0.01 wt % to 0.3 wt %; and titanium (Ti) in a range from 0.01 wt % to 0.3 wt %.

In other features, the chromium (Cr) is in a range from 1.2 wt % to 6 wt % and a ratio of Cr/Si is greater than 0.5 and less than 3. After hot stamping, the second PHS blank includes Cr-enriched carbides in a range from 0.1 vol. % to 10 vol. %.

In other features, after pressing, forming, and quenching, the weld seam includes Al less than 0.8 wt. % and Cr greater than 0.5 wt. %, and a microstructure of the weld seam includes ferrite less than 5 vol. %, martensite greater than 80 vol. %.

In other features, the component comprises one of a B pillar and a door ring.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example of a method for welding two or more PHS weld blanks, heat soaking the welded blanks in a furnace, and forming, pressing, and quenching the welded blanks to form a component according to the present disclosure;

FIG. 2A illustrates an example of a cross section of AlSi-coated PHS blanks during welding;

FIG. 2B illustrates an example of a cross section of AlSi-coated PHS blanks after welding;

FIG. 2C illustrates an example of a cross section of AlSi-coated PHS blanks after welding and forming;

FIGS. 3A and 3B illustrate examples of enlarged cross sections of a weld seam between the AlSi-coated PHS blanks during welding and stamping, respectively;

FIG. 3C illustrates an example of fracture in the weld seam located between AlSi-coated PHS blanks after stamping;

FIG. 4 is a flowchart of an example of a method for welding a first AlSi-coated PHS blank and a chromium-added PHS blank, heat soaking the welded blanks in a furnace, and forming, pressing, and quenching the welded blanks after heating according to the present disclosure;

FIG. 5 illustrates an example of aluminum (Al) and chromium (Cr) content in a weld seam between the AlSi coated PHS blank and the Cr-added PHS blank according to the present disclosure;

FIG. 6 is a graph illustrating engineering stress as a function of engineering strain percentage for base metals and various welded PHS blanks including the base metals;

FIG. 7 illustrated an example of hardness across a weld seam between the AlSi coated PHS blank and the Cr-added PHS blank according to the present disclosure;

FIG. 8A is a side view illustrating an example of the AlSi-coated PHS blank welded to the Cr-added PHS blank with different thicknesses arranged between liquid-cooled dies according to the present disclosure;

FIG. 8B is a graph illustrating an example of temperature as a function of time to illustrate cooling rates required for different microstructures; and

FIG. 9 is a plan view illustrating an example of a door ring including more than two PHS weld blanks.

In the drawings, reference numbers may be reused to identify similar and/or identical elements.

### DETAILED DESCRIPTION

While a component manufacturing method according to the present disclosure using laser-welded press hardening steel (PHS) blanks is described in the context of structural components for vehicles, the method can be used for other manufacturing applications.

During press-hardening of steel, two or more PHS blanks are laser welded, heated to an austenitizing temperature for a predetermined period, transferred to a stamp/press while hot, and formed, pressed, and quenched between two or more dies. To avoid formation of the oxide layer, the PHS blanks are coated with an aluminum silicon alloy (AlSi) to inhibit oxide formation and to avoid cost and time required to remove the oxide after quenching, pressing, and forming.

The AlSi coating is dissolved into a weld seam between the PHS blanks during welding (e.g., laser welding), which causes formation of brittle intermetallics and/or soft ferrite. Current solutions for this problem (e.g., filler wire and laser ablation) are expensive and complicated to implement at high production levels.

During manufacturing of components using laser welded PHS blanks according to the present disclosure, a first PHS blank including an AlSi coating is welded to a second PHS blank that does not include the AlSi coating. The second PHS blank includes a higher level of chromium (Cr) than the first PHS blank. After welding, the welded PHS blanks are transferred to a furnace for austenitizing. After austenitizing, the welded PHS blanks are transferred to a stamp/press for quenching, pressing, and forming of the component.

Using the second PHS blank reduces coating contamination in the weld seam. The second PHS blank with added Cr increases the hardenability of the weld seam, which improves the strength and toughness of the component. The method according to the present disclosure allows laser welded PHS blanks to be joined using a greater number of thickness/material combinations.

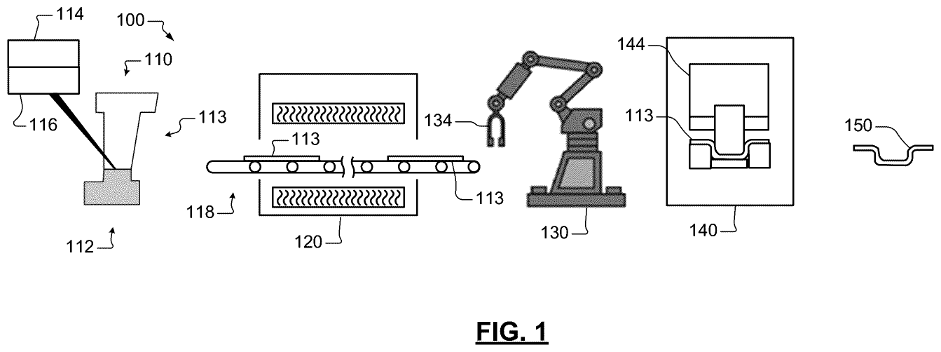

Referring now to FIG. 1, a first PHS blank 110 includes an AlSi coating. A second PHS blank 112 does not include the AlSi coating and includes increased chromium (Cr) relative to the first PHS blank as will be described further below. The first PHS blank 110 is welded (e.g., by a laser 116 and scanner 114) to the second PHS blank 112 to form a welded blank 113.

After welding, the welded blank 113 is transferred to a furnace 114 to heat soak the welded blank 113 at a temperature in a predetermined temperature range for austenitizing. In some examples, the predetermined temperature range is from 900° C. to 950° C. After austenitizing in the furnace 120, the welded blank 113 is transferred to a stamp/press 140 including two or more dies 144 for forming, pressing, and quenching to create a component 150. In some examples, a conveyor 120, a robot with an end effector 134, or other devices can be used to transfer the welded blank 113 to the furnace 120, through the furnace 120, and/or between the furnace 120 and the stamp/press 140.

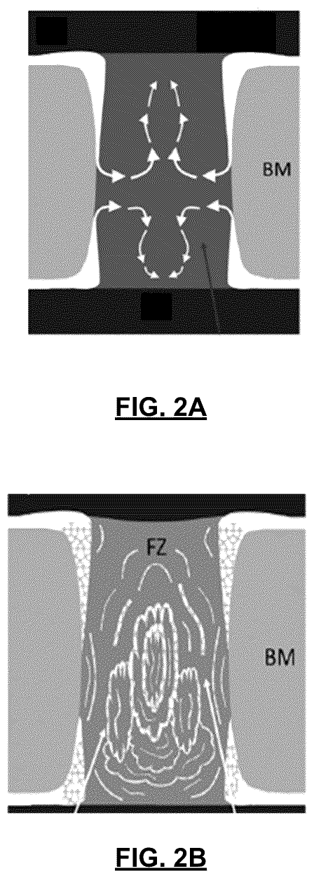

Referring now to FIGS. 2A to 2C, Al from the AlSi coating (shown in white) is dissolved during welding into a weld seam between the PHS blanks (as described in “A review on the laser welding of coated 22MnB5 press-hardened steel and its impact on the production of tailor-welded blanks”, Khan, Razmpoosh, and Zhou, 26 Mar. 2020, pages 447-467 (https://doi.org/10.1080/13621718.2020.1742472)). In FIG. 2A to 2C, both of the PHS blanks are coated with the AlSi coating. The PHS blanks are shown during welding in FIG. 2A and after welding in FIG. 2B. In FIG. 2C, the PHS blanks are shown after forming, pressing, and quenching. The AlSi coating causes formation of brittle intermetallics and/or soft ferrite.

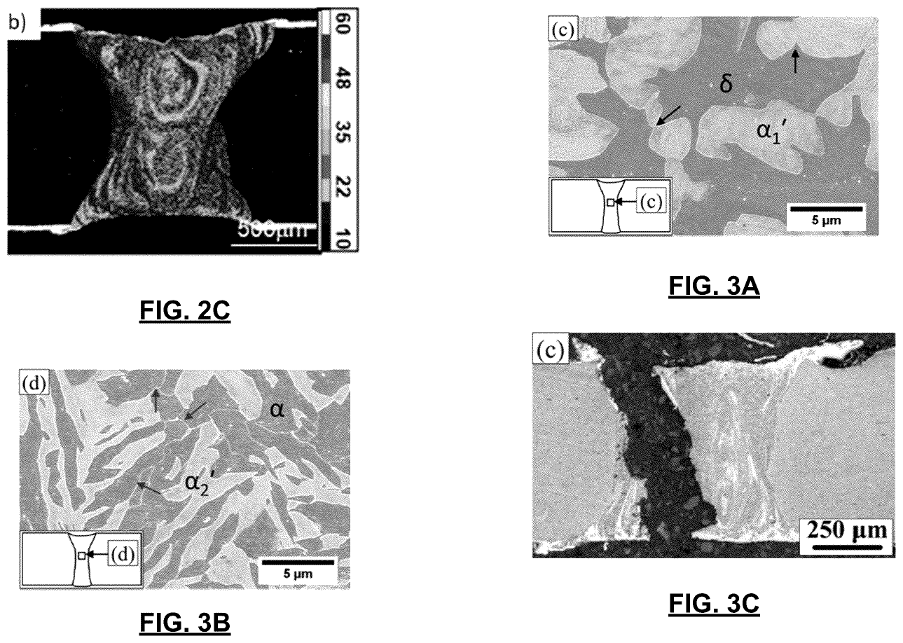

In FIGS. 3A to 3C, a weld seam is shown between two PHS blanks that are both coated with AlSi (as described in “A review on the laser welding of coated 22MnB5 press-hardened steel and its impact on the production of tailor-welded blanks”, Khan, Razmpoosh, and Zhou, 26 Mar. 2020, pages 447-467 (https://doi.org/10.1080/13621718.2020.1742472)). In FIG. 3A, a weld seam between the two PHS blanks is shown after welding. As can be seen, the Al introduces o-ferrite formation during welding. In FIG. 3B, a weld seam between the two PHS blanks is shown after forming, pressing, and quenching. The Al introduces a-ferrite formation during forming, pressing, and quenching. In FIG. 3C, fracture occurs at the weld seam after forming, pressing, and quenching.

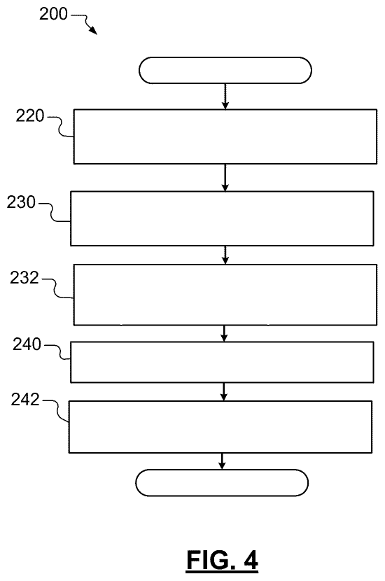

Referring now to FIG. 4, a method 200 for manufacturing a component is shown. At 220, an AlSi-coated PHS blank is welded to a Cr-added PHS blank. In some examples, laser welding is used. At 230, the welded blanks are transferred to a furnace. At 232, the welded blanks are heat soaked in the furnace at a predetermined temperature for a predetermined period. In some examples, the predetermined temperature is in a range from 900° C. to 950° C. In some examples, the predetermined period is sufficient for austenitizing the welded blank. At 240, the welded blanks are transferred to a stamp/press for quenching, forming, and pressing to form the component.

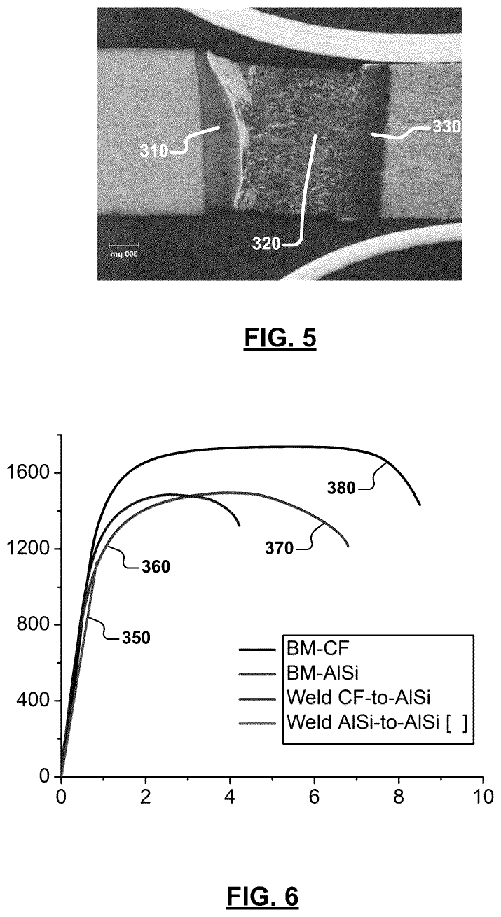

Referring now to FIG. 5, the welded blanks are shown prior to hot stamping. Within the Cr-added PHS blank (identified at 310), the Al content is at around 0 wt % and the Cr content is greater than 1.5 wt %. At the weld seam (identified at 320), the Al content is less than around 0.8 wt % and the Cr content is greater than 0.5%. At PHS blank with the AlSi coating (identified at 330), the Al content is around 0 wt % and the Cr content is around 0 wt %.

Referring now to FIG. 6, engineering stress in MPa is shown as a function of engineering strain percentage for various samples including base metal and welded PHS blanks. Performance of a first sample 350 including an AlSi-coated PHS blank welded to an AlSi-coated PHS blank without filler wire or ablation (e.g., AlSi-coated 22MnB5 steel). The first sample experienced early fracture at the weld seam. Performance of a second sample 260 including a coating free PHS blank welded to an AlSi-coated PHS blank. The second sample 260 had higher tensile properties than the first sample 350 and experienced ductile fracture at the base metal. Performance of a third sample 360 included base metal of AlSi-coated 22 MnB5. Performance of a fourth sample 370 included base metal of coating free steel.

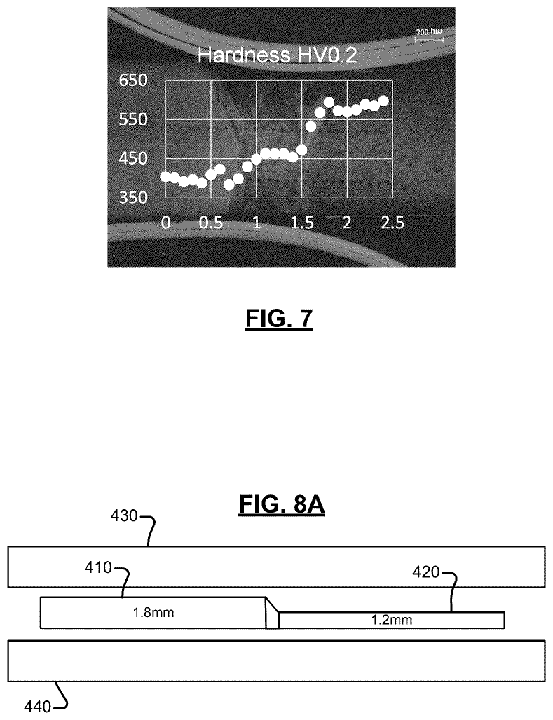

Referring now to FIG. 7, hardness is shown in a direction from the first PHS blank with the AlSi coating, to the weld seam, to the second PHS blank (without the Cr-added AlSi coating). Hardness values transition smoothly across the welded PHS blanks without a sudden decrease in hardness.

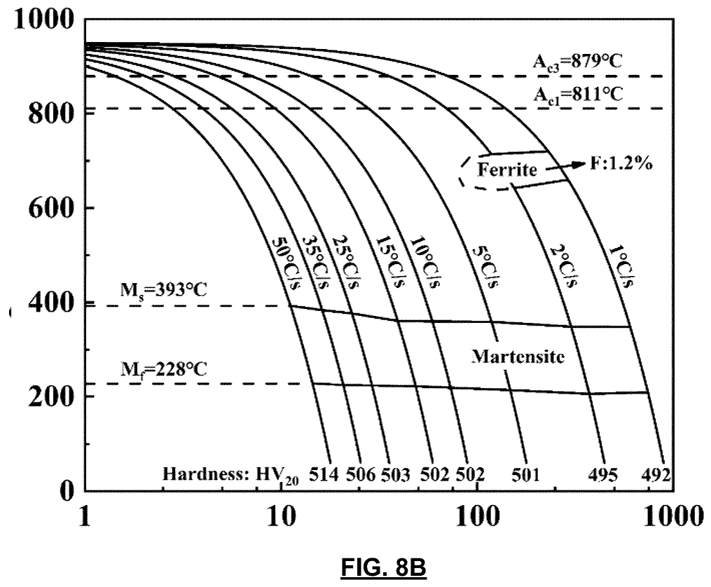

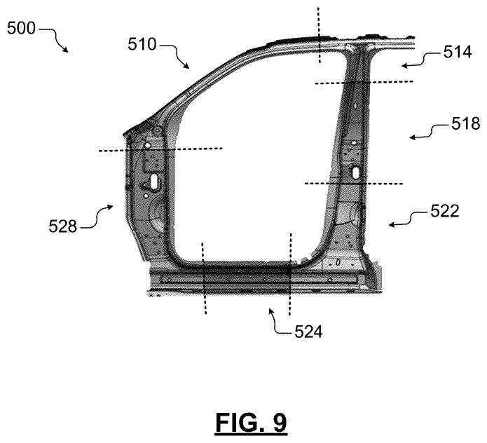

Referring now to FIGS. 8A and 8B, the welded PHS blanks according to the present disclosure can be manufactured with additional thickness combinations. In FIG. 8A, first and second weld blanks 410 and 420 having different thicknesses (e.g., 1.8 mm and 1.2 mm) are arranged between dies 430 and 440 with water cooling channels. An air gap is formed between the second weld blank 420 and the die 430 due to the lower thickness. The Cr-added PHS blank increases hardenability. Due to the change in microstructure of the Cr-added PHS blank, lower cooling rates can be used as can be seen in FIG. 8B. The critical cooling rate can be as low as 5° C./s. In other words, the Cr-added PHS blank can be hardened by air cooling.

Referring now to FIG. 9, examples of components that incorporate welded PHS blanks (including the PHS blank with the AlSi coating and the Cr-added PHS blank) include B pillars, a door ring, and/or other components. The components can include more than two PHS blanks. For example, the B pillar can include the PHS blank with the AlSi coating welded to the Cr-added PHS blank. For example, a door assembly can include additional PHS blanks that are joined.

The door ring 500 in the example in FIG. 9 includes frame portions 510, 514, 518, 522, 524, and 528 that are joined to form the door ring 500. A mixture of the PHS blanks with the AlSi coating, the Cr-added PHS blanks, and/or uncoated PHS blanks can be used. In this example, the frame portion 510 can include 1.2 mm 1200 MPa Cr-added PHS. The frame portion 514 can include 1.2 mm 2000 MPa bare PHS (conventional). The frame portion 518 include 1.4 mm 1700 MPa Cr-added PHS. The frame portion 522 can include 1.8 mm 600 MPa AlSi-coated PHS. The frame portion 524 includes 1.2 mm 1700 MPa Cr-added PHS. The frame portion 528 includes 1.3 mm 1500 MPa AlSi-coated PHS. As can be appreciated, other types of components may be manufactured.

In some examples, the PHS blank with added Cr includes iron (Fe), carbon (C) in a range from 0.05 wt % to 0.35 wt %, manganese (Mn) in a range from 0.05 wt % to 3.0 wt %, chromium (Cr) in a range from 1.2 wt % to 12 wt %, silicon (Si) in a range from 0.3 wt % to 2.0 wt %, nickel (Ni) in a range from 0 wt % to 1.5 wt %. vanadium (V) in a range from 0 wt % to 0.5 wt %, niobium (Nb) in a range from 0 wt % to 0.3 wt %, and titanium (Ti) in a range from 0 wt % to 0.3 wt %.

In some examples, the CR-added PHS blank includes one or more of Ni in a range from 0.01 wt % to 1.5 wt %, vanadium (V) in a range from 0.01 wt % to 0.5 wt %, niobium (Nb) in a range from 0.01 wt % to 0.3 wt %, and/or titanium (Ti) in a range from 0.01 wt % to 0.3 wt %.

In some examples, when Cr<6 wt %, a ratio of Cr/Si is greater than 0.5 and less than 3 for oxidation resistance during hot stamping. In some examples, Ni concentration is increased to further improve toughness of the fusion zone.

In some examples, the microstructure of Cr-added bare PHS blank after hot stamping includes a surface oxidation layer having a thickness less than 1.5 μm. The surface oxidation layer includes Fe—Cr—Si—Mn oxides. In some examples, the steel includes Cr-enriched carbides in a range from 0.1 vol. % to 10 vol. %. In some examples, the Cr in carbide is in a range from 10 wt % to 51 wt. % and a size of the carbide is in a range from 25 nm to 400 nm.

In some examples, the chemistry of weld seam after welding includes Al<0.8 wt. %, Cr>0.5 wt. % (e.g., averaged at different regions to include segregation). In other examples, the chemistry of weld seam after welding includes Al<(0.8 wt. %+½ Al in base steel 1+½ Al in base steel 2).

A microstructure of the weld seam after laser welding and hot stamping includes ferrite<5 vol. %, martensite>80 vol. %, a remaining vol. % comprising bainite and/or retained austenite, and Cr-enriched carbides<1 vol. %.

Mechanical properties of the weld seam after laser welding and hot stamping includes tensile fracture occurring away from the weld seam. Impact toughness is not lower than 80% of the softer base steel. Hardness is not lower than 90% of the softer base steel.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A method for manufacturing a component, comprising:
providing a first PHS blank including an aluminum silicon (AlSi) coating;
providing a second PHS blank,
wherein the second PHS blank includes chromium (Cr) at a higher concentration than the first PHS blank and does not include the aluminum silicon (AlSi) coating;
welding the first PHS blank to the second PHS blank to form a welded blank including a weld seam between the first PHS blank and the second PHS blank;
transferring the welded blank to a furnace;
heat soaking the welded blank in the furnace at a predetermined temperature for a predetermined period; and
pressing, forming, and quenching the welded blank in a stamp/press to form a component.

2. The method of claim 1, wherein the predetermined temperature is in a range from 900° C. to 950° C.

3. The method of claim 1, wherein the second PHS blank includes:
iron (Fe);
carbon (C) in a range from 0.05 wt % to 0.35 wt %;
manganese (Mn) in a range from 0.05 wt % to 3.0 wt %;
chromium (Cr) in a range from 1.2 wt % to 12 wt %; and
silicon (Si) in a range from 0.3 wt % to 2.0 wt %.

4. The method of claim 3, wherein the second PHS blank includes:
nickel (Ni) in a range from 0.01 wt % to 1.5 wt %;
vanadium (V) in a range from 0.01 wt % to 0.5 wt %;
niobium (Nb) in a range from 0.01 wt % to 0.3 wt %; and
titanium (Ti) in a range from 0.01 wt % to 0.3 wt %.

5. The method of claim 3, wherein the second PHS blank includes Ni in a range from 0.01 wt % to 1.5 wt %.

6. The method of claim 3, wherein the second PHS blank includes vanadium (V) in a range from 0.01 wt % to 0.5 wt %.

7. The method of claim 3, wherein the second PHS blank includes niobium (Nb) in a range from 0.01 wt % to 0.3 wt %.

8. The method of claim 3, wherein the second PHS blank includes titanium (Ti) in a range from 0.01 wt % to 0.3 wt %.

9. The method of claim 3, wherein the chromium (Cr) is in a range from 1.2 wt % to 6 wt % and a ratio of Cr/Si is greater than 0.5 and less than 3.

10. The method of claim 3, wherein, after pressing, forming, and quenching, the second PHS blank includes a surface oxidation layer having a thickness less than 1.5 μm.

11. The method of claim 1, wherein, after pressing, forming, and quenching, the second PHS blank includes Cr-enriched carbides in a range from 0.1 vol. % to 10 vol. %.

12. The method of claim 1, wherein, after pressing, forming, and quenching, the weld seam includes Al less than 0.8 wt. % and Cr greater than 0.5 wt. %.

13. The method of claim 1, wherein, after pressing, forming, and quenching, a microstructure of the weld seam includes ferrite less than 5 vol. %, martensite greater than 80 vol. %.

14. A component including two or more welded PHS blanks, comprising:
a first PHS blank including an aluminum silicon (AlSi) coating;
a second PHS blank,
wherein the second PHS blank includes chromium at a higher concentration than the first PHS blank and does not include the aluminum silicon (AlSi) coating; and
a weld seam between the first PHS blank and the second PHS blank.

15. The component of claim 14, wherein the second PHS blank includes:
iron (Fe);
carbon (C) in a range from 0.05 wt % to 0.35 wt %;
manganese (Mn) in a range from 0.05 wt % to 3.0 wt %;
chromium (Cr) in a range from 1.2 wt % to 12 wt %; and
silicon (Si) in a range from 0.3 wt % to 2.0 wt %.

16. The component of claim 15, wherein the second PHS blank further includes at least one of:
nickel (Ni) in a range from 0.01 wt % to 1.5 wt %;
vanadium (V) in a range from 0.01 wt % to 0.5 wt %;
niobium (Nb) in a range from 0.01 wt % to 0.3 wt %; and
titanium (Ti) in a range from 0.01 wt % to 0.3 wt %.

17. The component of claim 15, wherein the chromium (Cr) is in a range from 1.2 wt % to 6 wt % and a ratio of Cr/Si is greater than 0.5 and less than 3.

18. The component of claim 15, wherein, after hot stamping, the second PHS blank includes Cr-enriched carbides in a range from 0.1 vol. % to 10 vol. %.

19. The component of claim 14, wherein:
after pressing, forming, and quenching:
the weld seam includes Al less than 0.8 wt. % and Cr greater than 0.5 wt. %, and
a microstructure of the weld seam includes ferrite less than 5 vol. %, martensite greater than 80 vol. %.

20. The component of claim 14, wherein the component comprises one of a B pillar and a door ring.
